(19) United States
(12) Patent Application Publication
(10) Pub. No.: US 2012/0193328 A1
(43) Pub. Date: Aug. 2, 2012

(54) METHOD FOR MAKING A HOT WATER TANK OF FERRITIC STAINLESS STEEL WITH A TIG WELDED STRUCTURE

(75) Inventors: Toshiro ADACHI, Shunan-shi (JP); Akihiro NONOMURA, Shunan-shi (JP); Osamu YAMAMOTO, Shunan-shi (JP); Kouki TOMIMURA, Shunan-shi (JP)

(73) Assignee: NISSHIN STEEL CO., LTD., Tokyo (JP)

(21) Appl. No.: 13/435,538

(22) Filed: Mar. 30, 2012

(30) Foreign Application Priority Data
Mar. 29, 2007 (JP) 2007-088124

(51) Int. Cl. B23K 9/167

(52) U.S. Cl. 219/75

(57) ABSTRACT

Disclosed is a ferritic stainless steel for hot-water tanks with welded structure, comprising, in terms of % by mass, at most 0.02% of C, from 0.01 to 0.30% of Si, at most 1% of Mn, at most 0.04% of P, at most 0.03% of S, from more than 21 to 26% of Cr, at most 2% of Mo, from 0.05 to 0.6% of Nb, from 0.05 to 0.4% of Ti, at most 0.025% of N, and from 0.02 to 0.3% of Al, and optionally containing at least one of at most 2%, preferably from 0.1 to 2% of Ni and at most 1%, preferably from 0.1 to 1% of Cu, with a balance of Fe and inevitable impurities.

### TECHNICAL FIELD

The present invention relates to a ferritic stainless steel for hot-water tanks with welded structure as worked by TIG-welding, and to a hot-water tank comprising it.

### BACKGROUND ART

SUS444 of a ferritic stainless steel (low C, low N, (18-19 Cr)-(2 Mo)-(Nb, Ti) steel) is widely used as a material for hot-water tanks of electric water heaters, hot-water tanks, etc. SUS444 is a steel type developed mainly for enhancing the corrosion resistance of steel in hot-water environments.

The mainstream of a hot-water tank has a “welded structure” where the constitutive members comprising such as shell plate and upper and lower end plates are integrated by TIG-welding. When the hot-water tank having such a welded structure is used in hot-water environments of tap water, then the welded part is often corroded. In case of SUS444, when the corrosion mode is pitting corrosion, the steel may be readily re-passivated and the pitting corrosion thereof scarcely grows. However, in crevice corrosion, the steel is hardly re-passivated, and the corrosion may grow to penetrate a steel sheet in the thickness direction thereof, therefore often causing a leak of water therethrough. Accordingly, the structure of a hot-water tank is preferably so planned as to have few gaps therein. In the structure, however, some sites could hardly evade the formation of gaps therein owing to the production process for the structure, such as the welded part between the constitutive shell plate and end plates.

In producing a hot-water tank by TIG-welding, in general, there is employed a method of Ar back gas sealing to retard the oxidation on the side of the back bead, for the purpose of reducing the reduction in the corrosion resistance in the welded part. However, the need for the additional heating function of electric water heaters has increased, for which there has increased a tank structure with a bellows tube inserted therein. In this case, it is difficult to insert the nozzle for Ar back gas sealing in welding into the inside area of the tank structure, and therefore, there have increased cases of inevitably employing TIG-welding with no back gas sealing, and this is one factor of the risk for corrosion resistance depression.

On the other hand, from the recent global environmental issues, the demand for a CO₂ coolant heat-pump hot-water supplier (Ecocute®) smaller in power consumption than an electric water heater has increased. This system does not require heating with a heater, and therefore does not naturally require a flange for heater insertion thereinto; in this, however, a flange is indispensable for inserting a back gas sealing nozzle thereinto in TIG-welding, and this causes a problem of cost increase.

Patent Reference 1 describes a stainless steel-made body structure for water heaters in which the insertion depth of the end plate to the shell plate is up to 20 mm so as to evade the occurrence of crevice corrosion therein. A SUS444-level steel is employed as the steel material. However, as a result of the present inventors' investigations, the heat-affected zone in which the corrosion resistance lowers owing to welding is within a range of about 10 mm or so from the welding bead, and therefore, the above-mentioned structure could not attain a sufficient effect of enhancing the corrosion resistance of the welded part. When the SUS444-level steel is applied to TIG-welding with no Ar back gas sealing, it is presumed that the corrosion resistance may greatly worsen in the area with oxidation scale formed in the back bead part.

Patent Reference 2 describes a ferritic stainless steel with Ti and Al added thereto in combination, which may reduce Cr oxidation loss in welding and which is improved in point of the corrosion resistance in the welded part thereof. Using the steel of the type has made it possible to significantly increase the level of corrosion resistance of hot-water tanks. However, the steel could not also sufficiently reduce the Cr oxidation loss in TIG-welding with no Ar back gas sealing, and significant reduction in the corrosion resistance is inevitable.
Patent Reference 1: JP-A 54-72711
Patent Reference 2: JP-A 5-70899

### PROBLEMS THAT THE INVENTION IS TO SOLVE

As described in the above, a structure to which Ar back gas sealing is hardly applicable in its production by TIG-welding is increasing in recent hot-water tanks. On the other hand, from the demand for production cost reduction, it is now difficult to plan a hot-water tank structure with no gap in the welded part thereof. Given that situation, an object of the present invention is to develop and provide a ferritic stainless steel capable of exhibiting excellent corrosion resistance in hot-water environments where the welded steel is exposed to tap water directly as it is in hot-water tanks constructed by TIG-welding with no back gas sealing, and to provide a hot-water tank comprising the steel.

### DISCLOSURE OF THE INVENTION

The present inventors have made detailed studies for the purpose of attaining the above-mentioned object, and have found the following:

(i) Securing the Cr content of more than 21% by mass to increase the basic corrosion resistance level is extremely effective for enhancing the corrosion resistance of the welded part on the back bead side made by TIG-welding with no back gas sealing.

(ii) Ni and Cu enhance the corrosion resistance of a welded part, and their effect is larger when the Cr content is larger. Taking the application to hot-water environments in consideration, the corrosion resistance of the heat-affected zone on the back side welded by TIG-welding with no back gas sealing can be significantly enhanced by adding at least one of Ni or Cu to the steel having a Cr content of more than 21% by mass.

(ii) Regarding Si that has been said to be effective for enhancing the corrosion resistance of a welded part, when it is added in an amount more than a predetermined level, it rather worsens the corrosion resistance of the part welded by TIG-welding with no back gas sealing, on the back bead side where the welded part is as it is.

(iii) No known as a corrosion resistance-improving element is not effective for inhibiting the oxidation on the surface of a stainless steel, or that is; for improving the corrosion resistance of the welded part of the steel.

The invention provides a novel ferritic stainless steel of which the constitution of the ingredients is planned on the basis of the above-mentioned findings.

Specifically, the invention provides a ferritic stainless steel for hot-water tanks with welded structure, comprising, in terms of % by mass, at most 0.02% of C, from 0.01 to 0.30% of Si, at most 1% of Mn, at most 0.04% of P, at most 0.03% of S, from more than 21 to 26% of Cr, at most 2% of Mo, from 0.05 to 0.6% of Nb, from 0.05 to 0.3% or from 0.05 to 0.4% of Ti, at most 0.025% of N, and from 0.02 to 0.3% of Al, and optionally in accordance with the necessary corrosion resistance level, at least one of at most 2%, preferably from 0.1 to 2% of Ni, and at most 1%, preferably from 0.1 to 1% of Cu, with a balance of Fe and inevitable impurities. More preferably, the steel to which the invention is directed contains at least one of from 0.4 to 1% of Ni and from 0.4 to 1% of Cu.

The corrosion resistance level of the steel is as follows: The steel is worked into a cold-rolled, annealed and acid-washed steel sheet, then the steel sheet is TIG-welded with no back gas sealing, and the test piece having the welded part directly as it is untreated is tested in a dipping test where the test piece is dipped in an aqueous solution with 2000 ppm of Cl⁻ at 80° C. for 30 days (using a Pt assistant cathode), and after the test, the corrosion depth is at most 0.1 mm.

The wording “directly as it is untreated” means that the test piece is not treated for removing the oxidation scale formed in the welded part thereof (for mechanical removal by polishing or the like, or chemical removal by pickling or the like) and has the welded part originally as it is. The “welded part” is a region comprising a welding bead part and a heat-affected zone. For forming the welded part to be applied to the above-mentioned dipping test, employed is a method of forming a welding bead under the condition for forming a back bead (welded metal part appearing on the back of the sheet to which an arc is applied) with moving the TIG-welding arc given to the surface of the steel sheet at a constant speed (bead-on-plate method). In this method, back gas sealing is not given to the side of the back bead. In addition, no filler metal is used. The test piece is made to contain both the welded part and the substrate material part on both sides of the welded part.

The invention also provides a hot-water tank having a welded part formed by TIG-welding with no back gas sealing of a steel material comprising the above-mentioned stainless steel, which is used in such a manner that the TIG-welded part on the back bead side thereof is, directly as it is with no treatment given thereto, exposed to hot water. In the TIG-welding, if desired, a filler metal may be used like in ordinary TIG-welding. “Hot water” as referred to herein means water at 50° C. or higher.

When the ferritic stainless steel of the invention is used, the corrosion resistance of the welded part in hot-water environments is remarkably enhanced. In particular, even in a case where the steel is used in such a manner that the welded part on the back bead side thereof made by TIG-welding with no back gas sealing is, directly as it is with no treatment given thereto, exposed to high-temperature tap water, the steel keeps excellent corrosion resistance for a long period of time. Specifically, when a hot-water tank is formed of the steel by TIG-welding, it may have high reliability even when Ar back gas sealing is omitted. Therefore, according to the invention, the planning latitude for hot-water tanks in tap water environments that require high corrosion resistance can be broadened. In addition, the invention does not require the flange for back gas sealing in constructing hot-water tank structures for CO₂-coolant heat-pump hot-water suppliers for which the increase in the demand is expected in future, and therefore enables cost reduction in producing them.

### BRIEF DESCRIPTION OF THE DRAWINGS

FIG. 1 is a view schematically showing the outward appearance of the dipping test piece.

FIG. 2 is a view schematically showing the dipping test method.

FIG. 3 is a view schematically showing the test tank structure used in Example 2.

FIG. 4 is a view schematically showing a corrosion resistance test with an actual tank.

### BEST MODE FOR CARRYING OUT THE INVENTION

The ingredient elements constituting the ferritic stainless steel of the invention are described.

C and N are inevitable elements in steel. When the content of C and N is reduced, then the steel becomes soft and its workability is therefore bettered, and in addition, the formation of carbides and nitrides decreases and the weldability and the corrosion resistance of the welded part are bettered. Accordingly, in the invention, the content of C and N is preferably smaller. The acceptable content of C is up to 0.02% by mass; and that of N is up to 0.025% by mass.

In TIG-welding with Ar gas sealing, Si is effective for enhancing the corrosion resistance of the welded part. Contrary to this, however, the present inventors' detailed studies have revealed that in TIG-welding with no gas sealing, Si is rather a factor of worsening the corrosion resistance of the welded part. Accordingly, from the viewpoint of corrosion resistance, it is important to lower the Si content, and in the invention, the Si content is limited to a content of at most 0.30% by mass. More preferably, it is at most 0.20% by mass, even more preferably, less than 0.20% by mass. However, Si contributes toward hardening a ferritic steel, and therefore, in applications that require joint strength, for example, typically to high-pressure hot-water tanks that are directly connected to a water pipe, Si addition is advantageous. As a result of various studies, the Si content is desirably at least 0.01% by mass in order that the steel can enjoy the strength-enhancing effect of Si therein. Accordingly, in the invention, the Si content must be controlled to fall within a range of from 0.01 to 0.30% by mass, more preferably from 0.01 to 0.20% by mass. Mn serves as a deoxidizing agent in a stainless steel.

However, Mn lowers the Cr concentration in a passivated film, therefore being a factor of causing oxidation resistance reduction. In the invention, the Mn content is preferably lower, and is limited to a content of at most 1% by mass. In a stainless steel from scrap, Mn introduction in some degree is inevitable; and the steel must be so controlled that it does not contain too much Mn.

P detracts from the toughness of the substrate material and the welded part, and its content is preferably lower. However, phosphorus removal by refining from a Cr-containing steel in its melting production is difficult, and therefore, the reduction in the P content of steel is accompanied by excessive cost increase in carefully selecting the starting material. Accordingly, in the invention, the acceptable P content of the steel is up to 0.04% by mass like in an ordinary ferritic stainless steel.

S is known to form MnS that may be readily a starting point of pitting corrosion, therefore worsening the corrosion resistance of steel; however, in the invention, addition of a suitable amount of Ti to the steel is indispensable, and it is unnecessary to severely define the S content. Specifically, Ti has a strong affinity to S and forms a chemically stable sulfide, and therefore, the formation of MnS to cause corrosion resistance reduction is fully inhibited. On the other hand, however, when too much S is in the steel, the welded part may be readily cracked at a high temperature; and therefore, the S content; is limited to at most 0.03% by mass.

Cr is a main constitutive element of a passivated film, and therefore enhances local corrosion resistance such as pitting corrosion resistance and crevice corrosion resistance of steel. The corrosion resistance of the welded part of steel made by TIG-welding with no back gas sealing greatly depends on the Cr content, and therefore in the invention, Cr is an important element. The present inventors studies have revealed that the steel must secure a Cr content of more than 21% by mass in order that the part thereof welded with no back gas sealing can have good corrosion resistance enough in hot-water environments. The corrosion resistance-enhancing effect increases with the increase in the Cr content. However, when the Cr content is too high, it may be difficult to reduce C and N in the steel, therefore causing a factor of worsening the mechanical property and the toughness of the steel and increasing the cost thereof. In the invention, based on the finding that, in the steel having a Cr content of more than 21% by mass, the effect of Ni and Cu to enhance the corrosion resistance of the welded part of the steel increases, the above-mentioned problems are minimized and the steel can have sufficient corrosion resistance not relying upon further increase in the Cr content even in application to severe environments. Accordingly, in the invention, the Cr content is from more than 21 to 26% by mass.

Mo is an element effective for increasing the corrosion resistance level of steel along with Cr, and it is known that the corrosion resistance-enhancing effect of Mo increases higher with the increase in the Cr content of steel. However, the present inventors' detailed studies have revealed that the effect of Mo to enhance the corrosion resistance of the welded part on the back bead side made by TIG-welding with no back gas sealing is not so large. For the main use of the steel of the invention for use in hot-water environments of tap water, the Mo content of not less than 0.3% by mass is effective; however, when the Mo content is increased to a level of more than 2% by mass, then the negative factor of workability reduction and cost increase grows larger and is therefore undesirable. Accordingly, the Mo content is at most 2% by mass.

Nb has a high affinity to C and N, like Ti, and is an element effective for preventing intergranular corrosion problematic with ferritic stainless steel. For making Nb sufficiently exhibit its effect in the steel, the Nb content to be secured is desirably at least 0.05% by mass. However, when too much, Nb may cause a weld high-temperature cracking and may lower the toughness of the welded part of steel. Therefore, the uppermost limit of the Nb content is 0.6% by mass.

Ti is an element contributing toward the corrosion resistance enhancement in the welded part of steel formed by ordinary TIG-welding with Ar back gas sealing; however, the present inventors have found that, even in TIG-welding with no back gas sealing, Ti is still effective for noticeably enhancing the corrosion resistance of the welded part on the back bead side of steel. Though not always clear, the mechanism may be as follows: In TIG-welding with Ar back gas sealing, it is considered that an oxide film of mainly Al may be predominantly formed on the surface of the steel during welding, owing to addition of Ti as combined with Al thereto, and, as a result, the Cr oxidation loss could be thereby retarded. On the other hand, it is presumed that, in TIG-welding with no back gas sealing, Ti may exhibit the effect of promoting the repassivation after corrosion in the welded part, therefore enhancing the corrosion resistance of the welded part. In order that the steel can enjoy the effect of Ti as above, the steel desirably has a Ti content of at least 0.05% by mass. However, when the Ti content increases too much, the surface quality of the material may worsen and the welding bead may often have an oxide formed therein whereby the weldability of steel may worsen. Accordingly, the uppermost limit of the Ti content is 0.3% by mass or 0.4% by mass.

Added along with Ti to steel, Al prevents the reduction in the corrosion resistance by welding the steel. In order that Al can sufficiently exhibit its effect, the Al content is desirably at least 0.02% by mass. On the other hand, too much Al in steel may worsen the surface quality of the material and may lower the weldability thereof, and therefore the Al content is at most 0.3% by mass.

Ni increases the Cr concentration in the welding scale in TIG-welding with no Ar back gas sealing, therefore increasing the amount of chemically stable Cr₂O₃ to be formed therein and enhancing the corrosion resistance of the welded part. Further, Ni suppresses to progress the corrosion in the welded metal part (welding bead) and the heat-affected zone of steel, therefore enhancing the corrosion resistance of the welded part of steel made by TIG-welding with no back gas sealing. The effect is higher when the Cr content is higher. Regarding the weldability of steel, Ni is effective for increasing the viscosity of the welding metal, and is therefore advantageous for increasing the welding speed since it may broaden the acceptable welding condition range of ferritic stainless steel. Accordingly, the Ni content in the invention may be defined in accordance with the necessary corrosion resistance level of steel. Effectively, the Ni content to be secured in the invention is at least 0.1% by mass, more effectively at least 0.4% by mass. However, too much Ni therein will make the steel hard and will worsen the workability of the steel. Accordingly, Ni, if any, in the steel is within a range of at most 2% by mass.

Cu, when suitably added to steel, enhances the corrosion resistance of the part of steel TIG-welded with no Ar back gas sealing, especially suppressing the occurrence of pitting corrosion in the heat-affected zone of steel. In addition, like Ni, Cu suppresses to progress the corrosion in the welded metal part (welding bead) and the heat-affected zone of steel, therefore enhancing the corrosion resistance of the welded part of steel made by TIG-welding with no back gas sealing. The effect is higher when the Cr content is higher. Accordingly, the Cu content in the invention may be defined in accordance with the necessary corrosion resistance level of steel. Effectively, the Cu content to be secured for sufficient corrosion resistance enhancement in the invention is at least 0.1% by mass, more effectively at least 0.4% by mass. However, too much Cu therein will rather lower the corrosion resistance of steel, and therefore, Cu, if any, in the steel is within a range of at most 1% by mass.

The ferritic stainless steel as specifically planned in point of the constitutive ingredients thereof in the manner as above may be worked in an ordinary ferritic stainless steel sheet production process to give a cold-rolled annealed material, and thereafter this may be welded according to a TIG-welding process with no back gas sealing, thereby constructing a hot-water tank. Not requiring any post treatment, the hot-water tank may be used directly as it is under the condition where the welded part on the back bead side thereof formed with no back gas sealing (that is, the inner side of the tank) is directly exposed to hot water.

### EXAMPLES

### Example 1

A stainless steel having the chemical composition as in Table 1 was produced by melting, and then hot-rolled to a hot-rolled sheet having a thickness of 3 mm. Next, this was cold-rolled to have a thickness of 1.0 mm, then final-annealed at 1000 to 1070° C., and pickled to give a sample sheet.

TABLE 1

| | | Chemical Composition (mass. %) | | | | | | | | | | | | | |
|---|---|---|---|---|---|---|---|---|---|---|---|---|---|---|---|
| Group | No. | C | Si | Mn | P | S | Ni | Cr | Mo | Nb | Ti | Cu | Al | N | Remarks |
| Steel of the | 1 | 0.004 | 0.04 | 0.17 | 0.030 | 0.002 | 0.12 | 21.2 | 0.94 | 0.23 | 0.18 | 0.10 | 0.05 | 0.013 | |
| Invention | 2 | 0.009 | 0.02 | 0.20 | 0.028 | 0.003 | — | 24.1 | 1.10 | 0.24 | 0.14 | 0.11 | 0.06 | 0.018 | |
| | 3 | 0.006 | 0.06 | 0.21 | 0.026 | 0.005 | — | 24.4 | 0.52 | 0.25 | 0.18 | — | 0.09 | 0.017 | |
| | 4 | 0.004 | 0.11 | 0.19 | 0.028 | 0.010 | 0.52 | 23.8 | 0.95 | 0.24 | 0.18 | — | 0.14 | 0.015 | |
| | 5 | 0.006 | 0.07 | 0.23 | 0.033 | 0.002 | 0.49 | 24.2 | 0.95 | 0.28 | 0.16 | 0.46 | 0.04 | 0.017 | |
| | 6 | 0.008 | 0.10 | 0.23 | 0.033 | 0.002 | — | 25.2 | 1.08 | 0.28 | 0.20 | — | 0.04 | 0.017 | |
| | 7 | 0.008 | 0.31 | 0.15 | 0.035 | 0.003 | 1.02 | 21.1 | 0.98 | 0.20 | 0.25 | — | 0.06 | 0.009 | |
| | 8 | 0.010 | 0.32 | 0.20 | 0.030 | 0.002 | 0.50 | 21.3 | 0.95 | 0.21 | 0.18 | 0.52 | 0.04 | 0.010 | |
| Comparative | 9 | 0.008 | 0.05 | 0.19 | 0.036 | 0.006 | 0.19 | 20.2 | 1.08 | 0.18 | 0.21 | 0.03 | 0.05 | 0.007 | |
| Steel | 10 | 0.006 | 0.45 | 0.20 | 0.026 | 0.004 | 0.08 | 24.3 | 0.98 | 0.25 | 0.17 | 0.02 | 0.09 | 0.009 | |
| | 11 | 0.008 | 0.45 | 0.19 | 0.036 | 0.006 | 0.19 | 18.3 | 1.81 | 0.40 | 0.01 | 0.03 | 0.05 | 0.007 | SUS444 |
| | 12 | 0.006 | 0.41 | 0.20 | 0.026 | 0.004 | 0.08 | 22.1 | 0.98 | 0.25 | 0.17 | 0.02 | 0.09 | 0.009 | SUS445J1 |

The underline means that the composition is outside the scope of the invention.

Each sample steel sheet was TIG-welded according to a bead-on-plate method. The sheet was welded with no back gas sealing on the back of the welded part. Specifically, the sheet was welded in such a manner that the side thereof opposite to the side exposed to arc was kept exposed to air. The welding condition was as follows: The welding depth (in the welded metal part) could reach the back of the sheet and a “back bead” having a width of about 4 mm could be formed on the back of the sheet. Under the condition, the welding heat-affected zone (HAZ) is within a range of about 10 mm as the distance from the bead center in the center part of the thickness of the sheet.

From the sample from which the oxidation scale formed by welding was not removed (untreated sample), a test piece of 15×40 mm was cut out, and tested in a dipping test in hot water. FIG. 1 schematically shows the outward appearance of the dipping test piece. The test piece was so cut out that the welding bead could run to cross the center part in the lateral direction of the test piece. The dipping test piece contained a welding bead part, a heat-affected zone and both substrate parts. A lead wire was spot-welded to the edge of one of the substrate parts, and only the lead wire and its connection part were resin-coated.

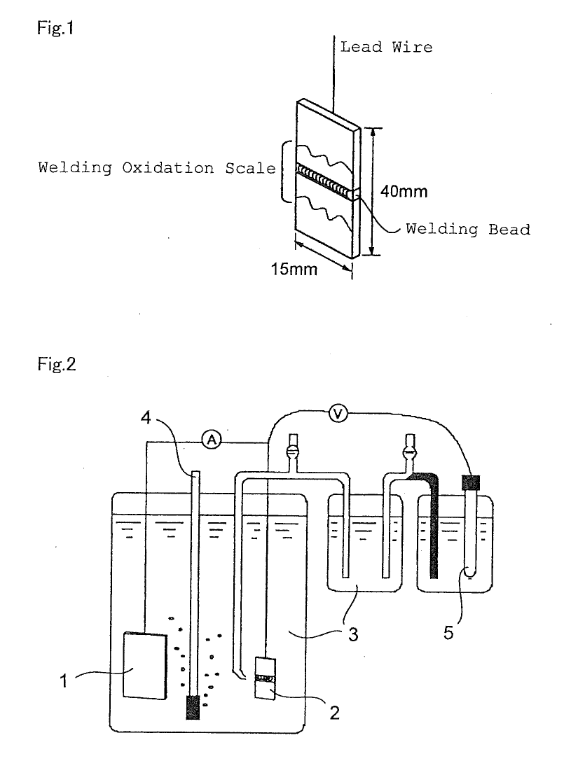

The dipping test was at 80° C. in an aqueous solution with 2000 ppm of Cl⁻ for 30 days. FIG. 2 graphically shows the dipping test method. A Pt counter electrode 1 was connected to the dipping test piece 2 to construct a galvanic pair. The Pt counter electrode 1 was produced by Pt-plating the surface of a Ti sheet of 40×60 mm. The dipping test piece 2 and the Pt counter electrode 1 were dipped in the test liquid 3; and during the test, air was introduced into the test liquid 3 through the aeration nozzle 4. In the test, n=3. During the test, the corrosion current was monitored. The time-dependent change of the corrosion current indicates the state of corrosion progress.

After the dipping test, the surface of the test piece was observed with a microscope, and the corrosion depth was measured. In this test, when the test piece tested is such that the final corrosion current is not larger than 1 μA and the maximum corrosion depth is not larger than 0.1 mm, then the test piece can be evaluated to have corrosion resistance in such that its corrosion does not grow in hot water environments of tap water. The corrosion depth of 0.1 mm corresponds to the uppermost depth at which the corrosion is repassivated and does no more grow. In case where the corrosion current decreased down to at most 1 pA and disappeared within 30 days in all test pieces of n=3, and where the maximum corrosion depth was at most 0.1 m in all the test pieces of n=3, the tested sample was evaluated good to pass the test. The results are shown in Table 2. In Table 2, the data of the corrosion depth is the maximum corrosion depth of all the test pieces of n=3. In every test piece, the maximum corrosion depth was measured at the site where an oxidation scale was formed in the welded part (bead part or heat-affected zone) on the back bead side of the test piece.

TABLE 2

| | | | Corrosion | Corrosion |
|---|---|---|---|---|
| Group | No. | Current | State | Depth (mm) |
| Steel of the | 1 | ABB | abb | 0.08 |
| Invention | 2 | AAB | aab | 0.06 |
| | 3 | AAB | aab | 0.06 |
| | 4 | AAA | aaa | 0.03 |
| | 5 | AAA | aaa | 0.01 |
| | 6 | AAA | aaa | 0.01 |
| | 7 | AAA | aaa | 0.05 |
| | 8 | AAA | aaa | 0.05 |
| Comparative | 9 | BCC | bcc | 0.29 |
| Steel | 10 | ACC | acc | 0.18 |
| | 11 | CCC | ccc | 0.35 |
| | 12 | CCC | ccc | 0.21 |

-Evaluation-
[Current]
A: The corrosion current disappeared within 7 days (at most 1 μA).
B: The corrosion current disappeared within 30 days (at most 1 μA).
C: The corrosion current continued for 30 days or more (more than 1 μA).
[Corrosion State]
a: Corrosion depth, at most 0.05 mm.
b: Corrosion depth, from more than 0.05 to 0.1 mm.
c: Corrosion depth, more than 0.1 mm.

As is known from Table 2, the samples of the invention having the chemical composition defined in the invention were all good in point of the corrosion resistance, and passed the dipping test. Specifically, in the state thereof still having the oxidation scale formed in TIG-welding with no back gas sealing, all the samples were confirmed to have excellent corrosion resistance in hot water environments. In comparison of No. 1 steel (21Cr-1Mo), No. 2 steel (24Cr-1Mo) and No. 6 steel (25Cr-1Mo), the corrosion current tends to more stably disappear in early stages and the corrosion depth tends to be small when the Cr content is larger. In particular, in No. 6 steel, the corrosion current disappeared within 7 days and the maximum corrosion depth was 0.01 mm and was extremely small, and the welded part of the steel exhibited excellent corrosion resistance. The maximum corrosion depth of No. 2 steel (24Cr-1Mo) and that of No. 3 steel (24Cr-0.5Mo) were the same; and increasing Mo in the steel was almost ineffective for enhancing the corrosion resistance in the TIG-welded part with no back gas sealing. In No. 7 steel (21Cr-1Mo-1Ni), No. 8 steel (21Cr-1Mo-0.5Ni-0.5Cu), No. 4 steel (24Cr-1Mo-0.5Ni) and No. 5 steel (24Cr-1Mo-0.5Ni-0.5Cu), the Ni and/or Cu content was sufficiently high. In these, the corrosion current disappeared within 7 days and the maximum corrosion depth was not more than 0.05 mm and was small; and the welded part of these steels exhibited excellent corrosion resistance. The corrosion resistance of No. 7 steel and No. 8 steel in which the Ni and Cu content was sufficiently high was better than the corrosion resistance of No. 1 steel (21Cr-1Mo-0.1Cu-0.1Ni) in which the Ni and Cu content was relatively small, and this proves the corrosion resistance-enhancing effect of Ni and Cu in the steel. It is known that though No. 7 steel and No. 8 steel have a relatively low Cr content, their corrosion resistance level is higher than that of No. 2 steel (24Cr-1Mo-0.1Cu) and No. 3 steel (24.5Cr-0.5Mo) having a relatively high Cr content. In comparison between No. 8 steel (21Cr-1Mo-0.5Ni-0.5Cu) and No. 5 steel (24Cr-1Mo-0.5Ni-0.5Cu), it may be said that the corrosion resistance-enhancing effect of Ni and Cu increases when the Cr content of the steel is higher.

On the other hand, the corrosion resistance of the welded part of No. 9 steel was poor since the Cr content of the steel was low. In No. 10 steel and No. 12 steel, the Cr content was enough, but the Si content was too much, and therefore the corrosion resistance of the welded part of these steels was poor. No. 11 steel is 18Cr-2Mo SUS444. In this steel, the corrosion resistance of the welded part on the back bead side with no back gas sealing was lower than that in the steels of the invention, and the effect of Mo added to that No. 11 steel for enhancing the corrosion resistance of the welded part was poor.

### Example 2

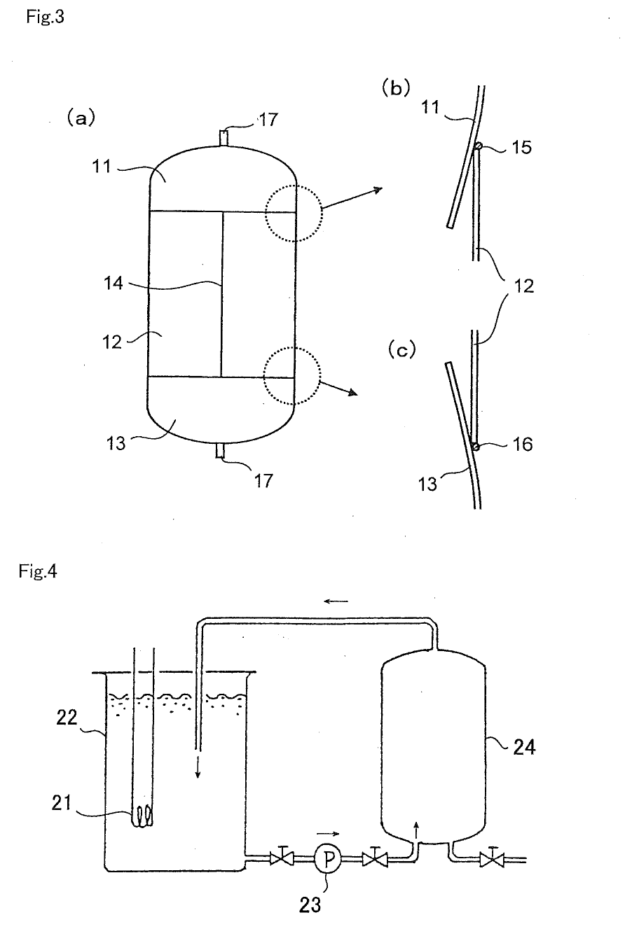

This is to demonstrate the corrosion resistance of the welded part of steel in an actual hot-water tank. A test tank structure of No. 2 steel of the invention, and a test tank structure of No. 9 steel of a comparative sample (SUS444) were constructed. FIG. 3 schematically shows the constitution of the test tank structure. FIG. 3(a) shows the outward appearance of the test tank structure. The test tank structure has a TIG-welded constitution of an upper end plate 11, a shell plate 12 and a lower end plate 13, and has a corner-rounded cylindrical form having a height of 1430 mm, a width of 520 mm and a capacity of 370 L. The shell plate body was formed by TIG-welding of the edges of a cylindrically-curved steel sheet, and has a welded part 14. A connector (mouthpiece) 17 was fitted to the upper end plate 11 and to the lower end plate 13. The above-mentioned test steel was used for the material of the upper end plate 11, the shell plate 12 and the lower end plate 13. FIG. 3(b) schematically shows the structure of the cross section of the welded part of the upper end plate 11 and the shell plate 12. FIG. 3(c) schematically shows the structure of the cross section of the welded part of the lower end plate 13 and the shell plate 12. In these welded parts 15 and 16, the edge of the end plate member steps in the inner surface side of the tank to form a weld gap. The welded parts 14, 15 and 16 were formed by TIG-welding with no back gas sealing. As filler metal, used was SUS316L.

FIG. 4 schematically shows a corrosion resistance test method with an actual tank. In the test liquid drum 22, the test liquid was heated up to 80° C. with the heater 21, and via the liquid-feeding pump 23, the test liquid was introduced into the test tank structure 24 through the bottom mouthpiece thereof at a constant flow rate of 10 L/min, and during the test, the liquid was circulated for a total of 60 days. The welded parts 14, 15 and 16 of the test tank structure 24 were untreated, and those welded parts were kept exposed to the test liquid on the back bead side thereof formed by welding with no back gas sealing. The test liquid was an aqueous solution with 2000 ppm of Cl⁻, as collected from the tap water in Sunan-shi, Yamaguchi-ken, to which was added 2 ppm of Cu²⁺ as an oxidizing agent. Cu²⁺ at that concentration has an oxidizing power nearly comparable to that of the remaining chlorine in hot water; however, since its concentration decreases with the progress in corrosion, the liquid was renewed every 7 days. Cl⁻ was prepared from NaCl; and Cu²⁺ was from a reagent of CuCl₂.2H₂O. The liquid temperature was controlled to be 80° C. in the test liquid drum 300 L in volume. After the test, the tank structure was dismantled, and checked for the corrosion, if any, in the welded parts 14, 15 and 16. The results are shown in Table 3.

TABLE 3

| Group | No. | Checked Portion | Corrosion | Remarks |
|---|---|---|---|---|
| Sample of | 2 | shell plate/shell plate | A | |
| the Invention | | (welded part 14) | | |
| | | upper end plate/shell plate | A | |
| | | (welded part 15) | | |
| | | lower end plate/shell plate | A | |
| | | (welded part 16) | | |
| Comparative | 9 | shell plate/shell plate | A | SUS444 |
| Sample | | (welded part 14) | | |
| | | upper end plate/shell plate | B | |
| | | (welded part 15) | | |
| | | lower end plate/shell plate | D | |
| | | (welded part 16) | | |

-Evaluation for Corrosion Resistance-
A: No corrosion.
B: Slight corrosion (corrosion depth, not more than 0.1 mm).
C: Intense corrosion (corrosion depth, more than 0.1 mm).
D: Penetrated corrosion.

As is known from Table 3, the test tank structure of the sample of the invention did not corrode at all even in the welded parts 15 and 16 having a gap structure which is most problematic in point of the possibility of corrosion in a corrosion test for 60 days. Specifically, it has been confirmed that the tank structure of the invention as constructed by TIG-welding with no back gas sealing exhibits excellent corrosion resistance even when it is used directly as it is with no post-treatment for oxidation scale removal, in hot-water environments of tap water. On the other hand, the comparative test tank structure formed of a conventional steel SUS444 corroded in the gap of the welded part 16, forming penetrated corrosion therein.

1-8. (canceled)

9. A method of making a hot water tank with a TIG-welded structure comprising the steps of:
providing an upper end plate, a lower end plate, and a shell plate, that when welded together form the hot water tank, each of the upper end plate, the lower end plate and the shell plate comprising a ferritic stainless steel, the ferritic stainless steel having a composition comprising, in terms of % by mass,
at most 0.02% of C,
from 0.01 to 0.30% of Si,
at most 1% of Mn,
at most 0.04% of P,
at most 0.03% of S,
from more than 21 to 26% of Cr,
at most 2% of Mo,
from 0.05 to 0.6% of Nb,
from 0.05 to 0.3% of Ti,
at most 0.025% of N,
from 0.02 to 0.3% of Al,
with a balance of Fe and inevitable impurities;
positioning the upper and lower edges of the shell plate to contact outside surfaces of the upper and lower end plates, respectively, with a lower edge of the upper end plate and an upper edge of the lower end plate extending along an inner surface of the shell plate; and
TIG-welding the upper and lower edges of the shell plate to the outside surfaces of the upper and lower end plates, respectively, with no back gas sealing during the TIG-welding step.

10. A method of making a hot water tank with a TIG-welded structure comprising the steps of:
providing an upper end plate, a lower end plate, and a shell plate, that when welded together form the hot water tank, each of the upper end plate, the lower end plate and the shell plate comprising a ferritic stainless steel, the ferritic stainless steel having a composition comprising, in terms of % by mass,
at most 0.02% of C,
from 0.01 to 0.30% of Si,
at most 1% of Mn,
at most 0.04% of P,
at most 0.03% of S,
from more than 21 to 26% of Cr,
at most 2% of Mo,
from 0.05 to 0.6% of Nb,
from 0.05 to 0.3% of Ti,
at most 0.025% of N,
from 0.02 to 0.3% of Al,
and further containing at least one of at most 2% of Ni and at most 0.1% of Cu,
with a balance of Fe and inevitable impurities,
positioning the upper and lower edges of the shell plate to contact outside surfaces of the upper and lower end plates, respectively, with a lower edge of the upper end plate and an upper edge of the lower end plate extending along an inner surface of the shell plate; and
TIG-welding the upper and lower edges of the shell plate to the outside surfaces of the upper and lower end plates, respectively, with no back gas sealing during the TIG-welding step.

11. A method of making a hot water tank with a TIG-welded structure comprising the steps of:
providing an upper end plate, a lower end plate, and a shell plate, that when welded together form the hot water tank, each of the upper end plate, the lower end plate and the shell plate comprising a ferritic stainless steel, the ferritic stainless steel having a composition comprising, in terms of % by mass,
at most 0.02% of C,
from 0.01 to 0.30% of Si,
at most 1% of Mn,
at most 0.04% of P,
at most 0.03% of S,
from more than 21 to 26% of Cr,
at most 2% of Mo,
from 0.05 to 0.6% of Nb,
from 0.05 to 0.3% of Ti,
at most 0.025% of N,
from 0.02 to 0.3% of Al,
and further containing at least one of from 0.1 to 2% of Ni and from 0.1 to 1% of Cu,
with a balance of Fe and inevitable impurities,
positioning the upper and lower edges of the shell plate to contact outside surfaces of the upper and lower end plates, respectively, with a lower edge of the upper end plate and an upper edge of the lower end plate extending along an inner surface of the shell plate; and
TIG-welding the upper and lower edges of the shell plate to the outside surfaces of the upper and lower end plates, respectively, with no back gas sealing during the TIG-welding step.

12. A method of making a hot water tank with a TIG-welded structure comprising the steps of:
providing an upper end plate, a lower end plate, and a shell plate, that when welded together form the hot water tank, each of the upper end plate, the lower end plate and the shell plate comprising a ferritic stainless steel, the ferritic stainless steel having a composition comprising, in terms of % by mass,
at most 0.02% of C,
from 0.01 to 0.30% of Si,
at most 1 of Mn,
at most 0.04% of P,
at most 0.03% of S,
from more than 21 to 26% of Cr,
at most 2% of Mo,
from 0.05 to 0.6% of Nb,
from 0.05 to 0.4% of Ti,
at most 0.025% of N,
from 0.02 to 0.3% of Al,
with a balance of Fe and inevitable impurities,
positioning the upper and lower edges of the shell plate to contact outside surfaces of the upper and lower end plates, respectively, with a lower edge of the upper end plate and an upper edge of the lower end plate extending along an inner surface of the shell plate; and
TIG-welding the upper and lower edges of the shell plate to the outside surfaces of the upper and lower end plates, respectively, with no back gas sealing during the TIG-welding step.

13. A method of making a hot water tank with a TIG-welded structure comprising the steps of:
providing an upper end plate, a lower end plate, and a shell plate, that when welded together form the hot water tank, each of the upper end plate, the lower end plate and the shell plate comprising a ferritic stainless steel, the ferritic stainless steel having a composition comprising, in terms of % by mass,
at most 0.02% of C,
from 0.01 to 0.30% of Si,
at most 1% of Mn,
at most 0.04% of P,
at most 0.03% of S,
from more than 21 to 26% of Cr,
at most 2% of Mo,
from 0.05 to 0.6% of Nb,
from 0.05 to 0.4% of Ti,
at most 0.025% of N,
from 0.02 to 0.3% of Al,
and further containing at least one of at most 2% of Ni and at most 1% of Cu,
with a balance of Fe and inevitable impurities,
positioning the upper and lower edges of the shell plate to contact outside surfaces of the upper and lower end plates, respectively, with a lower edge of the upper end plate and an upper edge of the lower end plate extending along an inner surface of the shell plate; and
TIG-welding the upper and lower edges of the shell plate to the outside surfaces of the upper and lower end plates, respectively, with no back gas sealing during the TIG-welding step.

14. A method of making a hot water tank with a TIG-welded structure comprising the steps of:
providing an upper end plate, a lower end plate, and a shell plate, that when welded together form the hot water tank, each of the upper end plate, the lower end plate and the shell plate comprising a ferritic stainless steel, the ferritic stainless steel having a composition comprising, in terms % by mass,
at most 0.02% of C,
from 0.01 to 0.30% of Si,
at most 1% of Mn,
at most 0.04% of P,
at most 0.03% of S,
from more than 21 to 26% of Cr,
at most 2% of Mo,
from 0.05 to 0.6% of Nb,
from 0.05 to 0.4% of Ti,
at most 0.025% of N,
from 0.02 to 0.3% of Al,
and further containing at least one of from 0.1 to 2% of Ni and from 0.1 to 1% of Cu,
with a balance of Fe and inevitable impurities,
positioning the upper and lower edges of the shell plate to contact outside surfaces of the upper and lower end plates, respectively, with a lower edge of the upper end plate and an upper edge of the lower end plate extending along an inner surface of the shell plate; and
TIG-welding the upper and lower edges of the shell plate to the outside surfaces of the upper and lower end plates, respectively, with no back gas sealing during the TIG-welding step.

15. The method of claim 9, wherein the corrosion resistance level of the steel is such that, when the steel is worked into a cold-rolled, annealed and acid-washed steel sheet, then the steel sheet is TIG-welded with no back gas sealing, and the test piece having the welded part directly as it is untreated is tested in a dipping test where the test piece is dipped in an aqueous solution with 2000 ppm of at 80° C. for 30 days (using a Pt assistant cathode), and after the test, the corrosion depth is at most 0.1 mm.

16. The method of claim 9, wherein the hot-water tank is used in such a manner that the TIG-welded part on the back bead side thereof is, directly as it is with no treatment given thereto, exposed to hot water.

17. The method of claim 10, wherein the corrosion resistance level of the steel is such that, when the steel is worked into a cold-rolled, annealed and acid-washed steel sheet, then the steel sheet is TIG-welded with no back gas sealing, and the test piece having the welded part directly as it is untreated is tested in a dipping test where the test piece is dipped in an aqueous solution with 2000 ppm of Cl⁻ at 80° C. for 30 days (using a Pt assistant cathode), and after the test, the corrosion depth is at most 0.1 mm.

18. The method of claim 10, wherein the hot-water tank is used in such a manner that the TIG-welded part on the back bead side thereof is, directly as it is with no treatment given thereto, exposed to hot water.

19. The method of claim 11, wherein the corrosion resistance level of the steel is such that, when the steel is worked into a cold-rolled, annealed and acid-washed steel sheet, then the steel sheet is TIG-welded with no back gas sealing, and the test piece having the welded part directly as it is untreated is tested in a dipping test where the test piece is dipped in an aqueous solution with 2000 ppm of Cl⁻ at 80° C. for 30 days (using a Pt assistant cathode), and after the test, the corrosion depth is at most 0.1 mm.

20. The method of claim 11, wherein the hot-water tank is used in such a manner that the TIG-welded part on the back bead side thereof is, directly as it is with no treatment given thereto, exposed to hot water.

21. The method of claim 12, wherein the corrosion resistance level of the steel is such that, when the steel is worked into a cold-rolled, annealed and acid-washed steel sheet, then the steel sheet is TIG-welded with no back gas sealing, and the test piece having the welded part directly as it is untreated is tested in a dipping test where the test piece is dipped in an aqueous solution with 2000 ppm of Cl⁻ at 80° C. for 30 days (using a Pt assistant cathode), and after the test, the corrosion depth is at most 0.1 mm.

22. The method of claim 12, wherein the hot-water tank is used in such a manner that the TIG-welded part on the back bead side thereof is, directly as it is with no treatment given thereto, exposed to hot water.

23. The method of claim 13, wherein the corrosion resistance level of the steel is such that, when the steel is worked into a cold-rolled, annealed and acid-washed steel sheet, then the steel sheet is TIG-welded with no back gas sealing, and the test piece having the welded part directly as it is untreated is tested in a dipping test where the test piece is dipped in an aqueous solution with 2000 ppm of Cl⁻ at 80° C. for 30 days (using a Pt assistant cathode), and after the test, the corrosion depth is at most 0.1 mm.

24. The method of claim 13, wherein the hot-water tank is used in such a manner that the TIG-welded part on the back bead side thereof is, directly as it is with no treatment given thereto, exposed to hot water.

25. The method of claim 14, wherein the corrosion resistance level of the steel is such that, when the steel is worked into a cold-rolled, annealed and acid-washed steel sheet, then the steel sheet is TIG-welded with no back gas sealing, and the test piece having the welded part directly as it is untreated is tested in a dipping test where the test piece is dipped in an aqueous solution with 2000 ppm of Cl⁻ at 80° C. for 30 days (using a Pt assistant cathode), and after the test, the corrosion depth is at most 0.1 mm.

26. The method of claim 14, wherein the hot-water tank is used in such a manner that the TIG-welded part on the back bead side thereof is, directly as it is with no treatment given thereto, exposed to hot water.

27. The method of claim 9, further comprising a plurality of shell plates and welding opposing side edges of adjacent plates together.

28. The method of claim 10, further comprising a plurality of shell plates and welding opposing side edges of adjacent plates together.

29. The method of claim 11, further comprising a plurality of shell plates and welding opposing side edges of adjacent plates together.

30. The method of claim 12, further comprising a plurality of shell plates and welding opposing side edges of adjacent plates together.

31. The method of claim 13, further comprising a plurality of shell plates and welding opposing side edges of adjacent plates together.

32. The method of claim 14, further comprising a plurality of shell plates and welding opposing side edges of adjacent plates together.
